(19) United States
(12) Patent Application Publication
(10) Pub. No.: US 2025/0346092 A1
(43) Pub. Date: Nov. 13, 2025

(54) VEHICLE

(71) Applicant: TOYOTA JIDOSHA KABUSHIKI KAISHA, Toyota-shi (JP)

(72) Inventor: Hiroshi TAKEUCHI, Toyota-shi (JP)

(73) Assignee: TOYOTA JIDOSHA KABUSHIKI KAISHA, Toyota-shi (JP)

(21) Appl. No.: 19/046,591

(22) Filed: Feb. 6, 2025

(30) Foreign Application Priority Data
May 10, 2024 (JP) 2024-077475

(51) Int. Cl. B60H 1/00

(52) U.S. Cl. CPC B60H 1/00828; B60H 1/00742; B60H 1/00778; B60H 1/00978

(57) ABSTRACT

The vehicle includes a generator, an air conditioner for circulating a CO₂ coolant, a battery for supplying power to an auxiliary machine including the air conditioner, a CO₂ sensor, an occupant sensor for detecting the presence or absence of an occupant, and a controller, wherein the controller outputs a warning to the occupant without performing forced ventilation by the air conditioner when an ignition switch of the vehicle is off and an occupant is detected by the occupant sensor, and a detected concentration by CO₂ sensor exceeds a prescribed allowable concentration and a remaining charge level of the battery is less than a prescribed reference charge amount.

### CROSS-REFERENCE TO RELATED APPLICATION

This application claims priority to Japanese Patent Application No. 2024-077475 filed on May 10, 2024, incorporated herein by reference in its entirety.

### BACKGROUND

### 1. Technical Field

The present specification discloses a vehicle including an air conditioner for circulating a CO₂ refrigerant.

### 2. Description of Related Art

In general, an air conditioner is mounted on a vehicle. The air conditioner adjusts the temperature in the vehicle by adjusting the temperature of air by compressing, expanding, condensing, and evaporating a refrigerant in the process of circulating the refrigerant, and sending the air after the temperature adjustment into the vehicle. In recent years, it has been proposed to use, as the refrigerant of the air conditioner, a CO₂ refrigerant containing carbon dioxide (hereinafter referred to as “CO₂”) as a main component. Since the CO2 refrigerant has a lower global warming potential than fluorine-based refrigerants, the environmental impact can be reduced by using the CO₂ refrigerant.

SUMMARY

If the CO₂ refrigerant leaks due to damage to a refrigerant pipe or the like, the CO₂ concentration in the vehicle may increase. Therefore, a technology for suppressing the increase in the CO₂ concentration has been proposed hitherto. For example, Japanese Unexamined Patent Application Publication No. 2008-290701 (JP 2008-290701 A) discloses a vehicle air conditioner that uses CO₂ as a refrigerant. In the vehicle air conditioner, a CO₂ sensor detects the CO₂ concentration in the vehicle. In JP 2008-290701 A, when the CO₂ concentration exceeds a reference value, an alert is turned ON and a blower is operated in an outside air circulation mode to forcibly ventilate the inside of the vehicle. According to this technology, it is possible to suppress the CO₂ concentration in the vehicle from being excessively high.

In JP 2008-290701 A, however, the blower is constantly operated regardless of the remaining charge level of a battery. Depending on the remaining charge level of the battery, electric power may be insufficient before CO₂ is sufficiently discharged to the outside of the vehicle, and the CO₂ concentration in the vehicle cabin may increase excessively. Therefore, the occupant needs to take appropriate action against the increase in the CO₂ concentration prior to the power shortage, for example, to start an engine in order to operate an alternator or to get off the vehicle. In JP 2008-290701 A, however, no alert is given about the power shortage even in the case where the power shortage is likely to occur. Therefore, in the technology of JP 2008-290701 A, it is difficult for the occupant to predict the power shortage and take appropriate action.

Therefore, the present disclosure provides a vehicle that can appropriately alert an occupant when a power shortage is expected.

A vehicle of the present disclosure includes:
a generator configured to generate electric power along with drive of an engine;
an air conditioner configured to circulate a CO₂ refrigerant;
a battery configured to supply electric power to an auxiliary machine including the air conditioner;
a CO₂ sensor configured to detect a CO₂ concentration in a vehicle cabin;
an occupant sensor configured to detect presence or absence of an occupant; and
a controller.
   The controller is configured to, when an ignition switch of the vehicle is OFF, the occupant is detected by the occupant sensor, a concentration detected by the CO₂ sensor exceeds a predetermined permissible concentration, and a remaining charge level of the battery is lower than a predetermined reference charge level, output an alert to the occupant without performing forced ventilation by the air conditioner.

In this case,
the alert may be an alert that prompts the occupant to turn ON the ignition switch.

The controller may be configured to switch alert levels according to at least one of an elapsed period after output of the alert, the detected concentration, and the remaining charge level.

The alert levels may include at least a first alert level at which an alert is output only visually and a second alert level at which an alert including sound is output.

The controller may be configured to open a window of the vehicle in parallel with the alert or after output of the alert.

The controller may be configured to perform the forced ventilation by the air conditioner when the ignition switch of the vehicle is ON or the remaining charge level of the battery is equal to or higher than the reference charge level and the detected concentration exceeds the permissible concentration.

The controller may be configured to notify the occupant that an increase in the CO₂ concentration has occurred when the forced ventilation is performed due to the detected concentration exceeding the permissible concentration.

In the technology of the present disclosure, when the ignition switch is OFF and the remaining charge level is low, the alert is output without performing the forced ventilation. Accordingly, it is possible to prompt the occupant to take appropriate action while suppressing power consumption.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle;

FIG. 2 is a diagram illustrating a configuration of an air conditioner;

FIG. 3 is a flow chart showing a flow of control when CO₂ concentration is increased when the ignition switch is turned on; and

FIG. 4 is a flow chart showing a flow of control at the time of CO₂ concentration increase when the ignition switch is off.

### DETAILED DESCRIPTION OF EMBODIMENTS

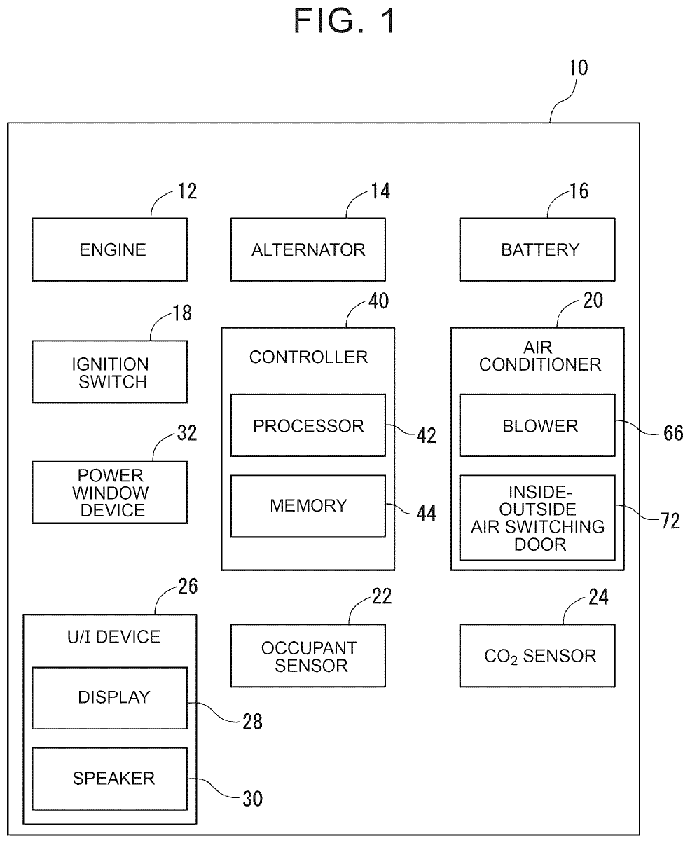

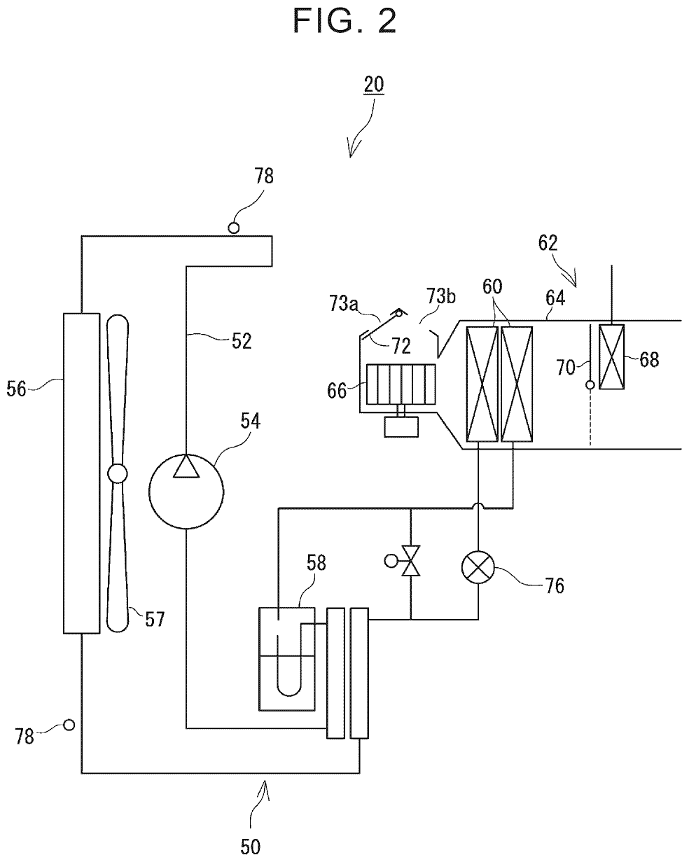

Hereinafter, the configuration of the vehicle 10 will be described with reference to the drawings. FIG. 1 is a block diagram illustrating a configuration of a vehicle 10. In FIG. 1, only the elements related to the increase in CO₂ concentration in the vehicle are extracted. FIG. 2 is a diagram illustrating a configuration of the air conditioner 20 mounted on the vehicle 10.

The vehicle 10 is an engine vehicle having an engine 12 as a power source, or a hybrid battery electric vehicle having an engine and a motor as a power source. The engine 12 is driven when the ignition switch 18 is turned on. The vehicle 10 travels by the output power of the engine 12. A part of the power of the engine 12 is output to the alternator 14. The alternator 14 is a generator that generates electric power by receiving power from the engine 12. The electric power generated by the alternator 14 is supplied to the auxiliary equipment including the air conditioner 20 and the battery 16. The battery 16 is a secondary battery capable of supplying power and charging. In FIG. 1, a single battery 16 is illustrated. However, the battery 16 may include a main battery that supplies electric power to a traveling motor (not shown) and a small auxiliary battery.

The air conditioner 20 adjusts the temperature inside the vehicle. The air conditioner 20 controls the temperature of the air supplied to the vehicle cabin by compressing, expanding, condensing, and evaporating the refrigerant in the process of circulating the refrigerant. The air conditioner 20 of the present embodiment uses a CO₂ refrigerant containing CO₂ as a main component as the refrigerant. The air conditioned by the air conditioner 20 is supplied to the vehicle cabin by the blower fan 66. Further, the inside/outside switching door 72 is a door for switching the intake port of the air conditioner 20, which will be described in detail later. By changing the position of the inside/outside switching door 72, the operation mode of the air conditioner 20 is switched between the inside air circulation mode and the outside air introduction mode.

The vehicle 10 is further equipped with an occupant sensor 22 and a CO₂ sensor 24. The occupant sensor 22 detects the presence or absence of an occupant in the vehicle. For example, the occupant sensor 22 is a weight sensor that detects the weight applied to the seat of the vehicle 10. As will be described in detail later, the controllers 40 change the control content at the time of CO₂ concentration increase depending on the presence or absence of the occupant. CO₂ sensor 24 detects CO₂ concentration in the vehicle. CO₂ sensor 24 may be disposed in the vehicle cabin or may be disposed in the blowout mechanism 62 (see FIG. 2) of the air conditioner 20. In any case, CO₂ sensor 24 is disposed at a position where leakage of CO₂ coolant can be detected at an early stage. The number of CO₂ sensors 24 is not limited to one, and a plurality of sensors may be provided. CO₂ concentration detected by CO₂ sensor 24 is transmitted to the controllers 40 as detected concentration Cd.

U/I device 26 is a device that presents an occupant with a message/warning regarding an increase in the CO₂ concentration. U/I device 26 includes a display 28 and a speaker 30. The display 28 is, for example, a liquid crystal or organic EL display that displays texts and images. The display 28 may also include one or more lamps to illuminate the icon image or to light the indicator lamp instead of or in addition to the display. The speaker 30 alerts the occupant by outputting sound. The power window device 32 is a device 10 for raising and lowering a window (not shown) of the vehicle 10.

The controller 40 controls driving of the above-described units. The controller 40 is physically a computer having a processor 42 and a memory 44. Although the controller 40 is illustrated as a single computer in FIG. 1, the controller 40 may be configured by combining a plurality of computers that are physically separated from each other. For example, the controllers 40 may include an engine ECU for controlling the engine 12, a battery ECU for controlling the battery 16, and an air-conditioning ECU for controlling the air conditioner 20.

Next, the configuration of the air conditioner 20 will be described. The air conditioner 20 includes a refrigerant circuit 50. The refrigerant circuit 50 is a circuit that 20 generates heat and latent heat by compressing, expanding, condensing, and evaporating the refrigerant in the process of circulating the refrigerant. Heat generated in the refrigerant circuit 50 is used for heating, and latent heat is used for cooling. Heretofore, a fluorine-based refrigerant has been frequently used as the refrigerant. However, there is a problem that the fluorine-based refrigerant has a high load on the environment. Therefore, in the present 25 embodiment, as described repeatedly, a CO₂ coolant containing CO₂ as a main component is employed. CO₂ refrigerants have lower global warming potential and lower environmental impact than fluorine-based refrigerants.

The refrigerant circuit 50 includes a refrigerant pipe 52 through which CO₂ refrigerant flows. A compressor 54, a condenser 56, an accumulator 58, a cooling expansion valve 76, and an evaporator 60 are provided in the middle of the path of the refrigerant pipe 52. The compressor 54 compresses the gaseous CO₂ refrigerant. The condenser 56 is a heat exchanger that exchanges heat between CO₂ coolant and the outside air. The condenser 56 functions as a condenser that condenses the gaseous CO₂ refrigerant during the cooling operation. A condenser fan 57 for efficiently taking in outside air is disposed behind the condenser 56.

The accumulator 58 gas-liquid separates CO₂ refrigerant and sends only the gaseous CO₂ refrigerant to the compressor 54. The cooling expansion valve 76 is a solenoid valve that is throttle-controlled during a cooling operation and is completely closed during a heating operation. When the cooling expansion valve 76 is throttled, CO₂ coolant is rapidly reduced in pressure when passing through the cooling expansion valve 76. The evaporator 60 is an evaporator for evaporating the liquid CO₂ refrigerant, and is disposed in a flow path of the air-conditioned air provided in the unit case 64. The latent heat generated during the evaporation cools the air around the evaporator 60.

Although not shown in FIG. 2, the refrigerant circuit 50 is provided with several solenoid valves for switching the direction in which the air-conditioning refrigerant flows. Further, a plurality of PT sensors 78 for detecting the pressure/temperature of CO₂ refrigerant flowing through the refrigerant pipe 52 are arranged in the refrigerant circuit 50.

A blowout mechanism 62 is disposed in the vehicle cabin. The blowout mechanism 62 is a mechanism that cools or heats air taken in from the outside or the inside of the vehicle and blows the air into the vehicle. The blowout mechanism 62 includes a unit case 64, a blower fan 66, and a heater core 68. At an upstream end of the unit case 64, an intake port 73a, 73b divided in two directions and an inside/outside switching door 72 are provided. One intake port 73a communicates with the vehicle cabin, and the other intake port 73b communicates with the exterior of the vehicle. Therefore, by changing the position of the inside/outside switching door 72, the communication destination of the unit case 64 is switched to the inside or outside of the vehicle cabin. Thus, the air-conditioning mode by the air conditioner 20 is switched between the inside air circulation mode and the outside air introduction mode.

Of course, when the blower fan 66 is driven in the outside air introduction mode, the inside of the vehicle is forced to ventilate, while the cooling and heating efficiency is lowered. Therefore, the controller 40 operates the air conditioner 20 in the indoor air circulation mode in principle, except in a specific case. The specific cases include, for example, a case in which the outside air introduction mode is designated by the occupant and a case in which the detected concentration Cd of CO₂ exceeds the allowable concentration Cp.

The downstream end of the unit case 64, the air outlet (not shown) for guiding the air conditioning air into the vehicle is formed. Further, an evaporator 60 and a heater core 68 are disposed in the unit case 64. During the cooling operation, the evaporator 60 cools the air sent from the blower fan 66 by the latent heat when the air-conditioning refrigerant is vaporized. The cooled air-conditioned air is output to the interior of the vehicle, thereby cooling the interior of the vehicle.

The heater core 68 is heated by another heat source during the heating operation. The other heat source may be, for example, the engine 12 or an electric heater. The heater core 68 is heated directly by another heat source or indirectly through a refrigerant such as water. A mode switching door 70 is disposed upstream of the heater core 68. The mode switching door 70 adjusts the amount of air passing through the heater core 68. During the heating operation, the mode switching door 70 moves to a position where the wind toward the heater core 68 is not blocked (a position indicated by a broken line in FIG. 2). As a result, the air sent from the blower fan 66 passes through the heater core 68 and is heated. The heated air-conditioned air is output into the vehicle cabin to thereby heat the vehicle cabin.

Incidentally, CO₂ refrigerant may leak into the vehicle cabin due to, for example, damage to the refrigerant pipe 52. Of course, CO₂ concentration in the vehicle cabin increases. The controller 40 starts control for decreasing CO₂ concentration when the detected concentration Cd of CO₂ exceeds the allowable concentration Cp. Specifically, the controller 40 switches the air conditioner 20 to the outside air introduction mode and then operates the blower fan 66 to forcibly ventilate the vehicle cabin.

Here, power must of course be supplied to the blower fan 66 for forced ventilation. Since the alternator 14 generates electric power during the period in which the engine 12 is being driven, sufficient electric power can be secured. On the other hand, when the ignition switch 18 is turned off and the engine 12 is stopped, power supplied to the blower fan 66 may be insufficient. As a result, there is a possibility that electric power is insufficient and CO₂ concentration in the vehicle cabin becomes excessively high prior to CO₂ being sufficiently discharged from the vehicle cabin.

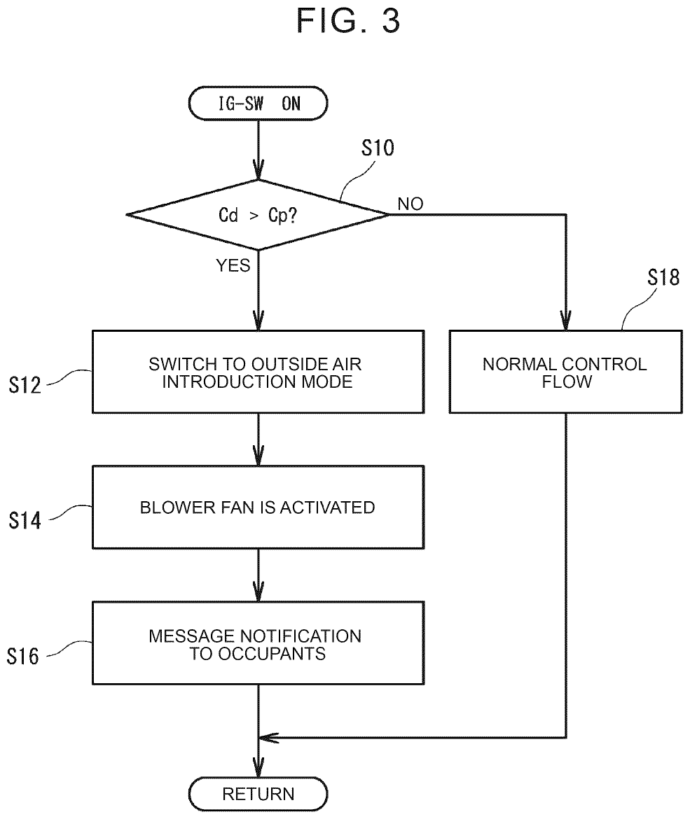

Therefore, in the present embodiment, the control content at the time of CO₂ concentration increase is changed in accordance with the on/off state of the ignition switch 18 and the remaining charge level Pd of the battery 16. This will be described below. First, the control when the ignition switch 18 is turned on at the time of increasing CO₂ concentration will be described referring to FIG. 3.

Here, the controller 40 periodically repeats the comparison between the detected concentration Cd outputted from CO₂ sensor 24 and a predetermined allowable concentration Cp (S10). The allowable concentration Cp is a reference value defined in advance and is a value higher than a typical indoor CO₂ concentration. For example, the “Act on Securing a Hygienic Environment in Buildings” stipulates that CO₂ level for maintaining an indoor environment is not more than 1,000 ppm. 1,000 ppm may be set as an allowable concentration Cp.

When the detected concentration Cd exceeds the allowable concentration Cp (Yes in S10), the controller 40 switches the position of the inside/outside switching door 72 to the position for the outside air introduction mode (S12). Thereafter, the controllers 40 operate the blower fans 66 to S14 the vehicle cabin. Accordingly, since the outside air is introduced into the vehicle cabin, an increase in CO₂ concentration in the vehicle cabin can be suppressed.

In addition, in this case, the controller 40 notifies the occupant of the message that the forced ventilation is being performed as CO₂ concentration increases through the display 28 (S16).

On the other hand, when the detected concentration Cd is equal to or less than the allowable concentration Cp (No in S10), the controller 40 executes a normal control flow (S18). For example, when air conditioning is required, the controller 40 operates the air conditioner 20 in the internal air circulation mode in principle.

The controllers 40 periodically repeat S18 process from the above S10. As a result, when CO₂ concentration in the vehicle cabin is high, the forced ventilation is continuously performed. When the ignition switch 18 is turned on, since the alternator 14 generates electric power, forced ventilation can be stably continued. As a consequence, CO₂ concentration can be suppressed from becoming excessively high.

As is apparent from the above description, the controller 40 outputs a message indicating that CO₂ concentration is increasing to the user when the forced ventilation is performed. As a result, the occupant can recognize that CO₂ concentration is increased for some reason. The occupant can then infer the reason for the increase in CO₂ concentration with the duration of the message indicating this increase in CO₂ concentration. For example, if the duration of the messaging is short, it can be inferred that CO₂ level has increased due to the breathing and insufficient ventilation of the occupant. On the other hand, if the duration of the messaging is long, it can be inferred that there is a higher possibility of CO₂ coolant leaking, rather than simply being insufficiently ventilated. Then, the occupant can take measures to deal with the leak of CO₂ coolant, for example, getting off the vehicle, or contact the maintenance shop.

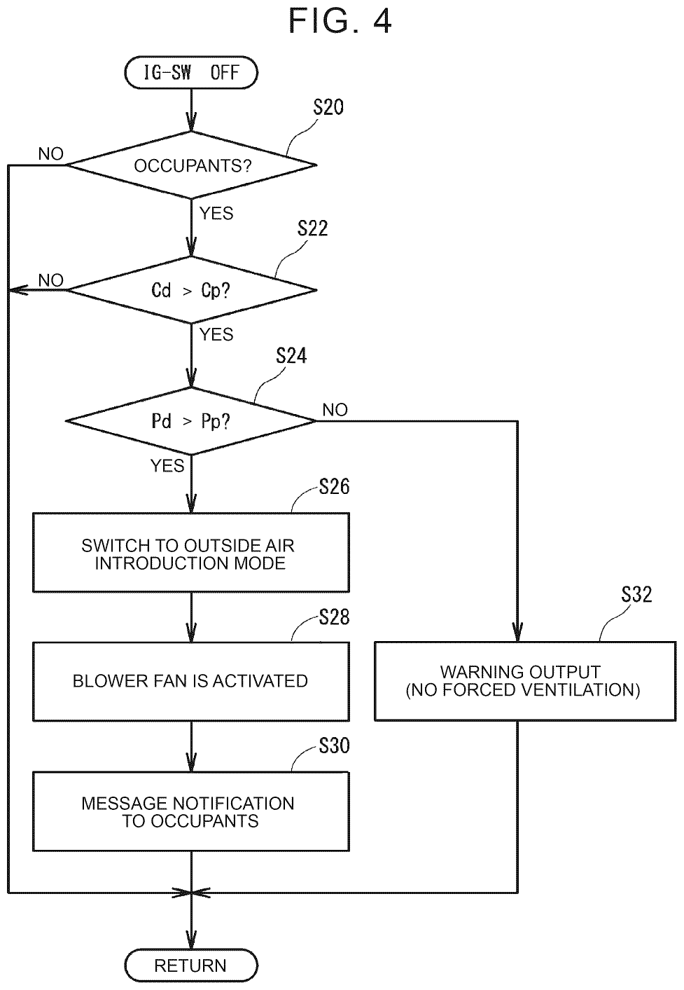

Next, the control at the time of increasing CO₂ concentration when the ignition switch 18 is off will be described referring to FIG. 4. When the ignition switch 18 is off, the controller 40 determines the presence or absence of an occupant in the vehicle cabin based on the detection result of the occupant sensor 22 (S20). When the controller 40 determines that there is no occupant in the vehicle cabin (No in S20), it stands by as it is. That is, when there is no occupant in the vehicle cabin, even if CO₂ concentration is high, there is no issue. Therefore, in order to suppress the power consumption, if there is no occupant, the vehicle stands by as it is.

On the other hand, when it is determined that there is an occupant in the vehicle cabin (Yes in S20), the controllers 40 compare the detected concentration Cd with the allowable concentration Cp (S22). When the detected concentration Cd is equal to or lower than the allowable concentration Cp (No in S22), the controllers 40 wait as they are. On the other hand, when the detected concentration Cd exceeds the allowable concentration Cp (Yes in S22), the controller 40 compares the remaining charge level Pd of the battery 16 with the predetermined reference charge level Pp (S24). Here, the reference charge level Pp is set to a charge amount capable of continuing the forced ventilation for a certain period of time. That is, when the ignition switch is turned off and the engine 12 is stopped, power generation by the alternator 14 is not performed, and the electric power of the battery 16 decreases as the in-vehicle electronic component is driven. Therefore, the duration during which the forced ventilation by the driving of the blower fan 66 can be continued varies depending on the remaining charge level Pd of the battery 16. Therefore, the controller 40 switches the content of the subsequent control in accordance with the remaining charge level Pd of the battery 16.

The reference charge level Pp may be a fixed value defined in advance or may be a variable value that varies in accordance with the latest power consumption amount. For example, when the power supply to the other than the blower fan 66 is large, the average consumption speed of the power is correspondingly high. If the remaining charge level Pd is not high to some extent, the blower fan 66 cannot be continuously operated for a sufficiently long time. Therefore, for example, the controller 40 may change the reference charge level Pp so that the reference charge level Pp becomes higher as the mean power consumption rate of the latest power (for example, from when the ignition switch 18 is turned off to the present) is higher.

If the remaining charge level Pd of the battery 16 is greater than the reference charge level Pp (Yes by S24), the controllers 40 executes forced ventilation (S26, S28). That is, after changing the inside/outside switching door 72 to the position for the outside air introduction mode, the blower fan 66 is operated. In addition, the controller 40 notifies the occupant of a message indicating that the forced ventilation is being performed as CO₂ concentration increases (S30).

On the other hand, when the remaining charge level Pd is less than the reference charge level Pp (No in S24), the controller 40 notifies the occupant of the warning through the display 28 and the speaker 30 without performing the forced ventilation (S32). This alert notifies the occupant that CO₂ level is increasing and prompts the occupant to turn on the ignition switch 18. Further, an alarm sound is output through the speaker 30. When the sound is outputted, the occupant can more reliably grasp the increase in CO₂ concentration and the necessity of starting the engine.

At this time, the controller 40 may drive the power window device 32 to open the window. Opening the windows can suppress CO₂ level from becoming excessively high even in the absence of forced ventilation. As a consequence, even when power is insufficient, an excessive increase in CO₂ concentration in the vehicle cabin can be suppressed. Thereafter, the controllers 40 repeatedly perform the process of detecting CO₂ concentration and the process according to CO₂ concentration until all the occupants get off.

As is obvious from the above explanation, in the present example, when the ignition switch 18 is off, the remaining charge level Pd of the battery 16 is checked, and when the remaining charge level Pd is low, an alert is notified without performing forced ventilation. As a result, the occupant can easily notice an increase in CO₂ concentration, and can take some measures (for example, turning on the ignition switch 18 or getting off the vehicle) at an early stage. In addition, in this case, since forced ventilation is not performed, power consumption can be suppressed, and power for continuing to notify a warning can be sufficiently secured for a period until the user takes an appropriate response.

The warning also prompts the occupant to turn on the ignition switch 18. Then, the occupant turns on the ignition switch 18 to start the engine 12, thereby eliminating power shortage and enabling forced ventilation. As a result, the occupant can continue to use the vehicle 10 as it is.

Note that any of the configurations described above is an example, and other configurations may be changed as long as the configuration described in claim 1 is provided. For example, in the above explanation, the windows are opened only when the remaining charge level Pd is less than the reference charge level Pp. However, even when the remaining charge level Pd is larger than the reference charge level Pp or even when the ignition switch 18 is turned on, the windows may be opened when the detected concentration Cd exceeds the allowable concentration Cp.

In addition, the form of the warning notified when the power is insufficient may be changed as appropriate. For example, in the above description, when the warning is notified, both a visual warning and an audible warning are output from the beginning. However, the level of the warning may vary depending on the situation. For example, the level of the warning may be switched according to at least one of the elapsed time after the warning is outputted, the detected concentration Cd, and the remaining charge level Pd. In this case, the level of the warning may include at least a first warning level for outputting only the visual warning and a second warning level for outputting the warning including the sound. Thus, for example, a warning of a first warning level that does not output a sound may be output first. Thereafter, when the predetermined period of time has elapsed, or the detected concentration Cd exceeds the upper limit concentration higher than the allowable concentration Cp, or the remaining charge level Pd becomes lower than the lower limit charge amount lower than the reference charge level Pp, a warning of the second warning level for outputting a sound may be output.

In this way, in the initial stage, a slight warning that does not include a sound is made to suppress, for example, excessive discomfort from being given to the occupant. That is, a warning with a sound is strongly irritated and easily causes discomfort to an occupant. Therefore, in the warning in the initial stage, the discomfort of the occupant can be reduced by not outputting the sound. On the other hand, when the degree of urgency is increased, a warning accompanied by a sound is output, so that an appropriate response can be strongly urged to the occupant.

In addition, the content of the warning does not necessarily have to be a content for prompting the occupant to turn on the ignition switch 18 as long as the occupant can prompt the occupant to appropriately respond to CO₂ increase in the event of a power shortage. For example, the warning may be a content that prompts the occupant to get off the vehicle. In addition, the alert may only notify the occupant that the present condition, i.e., CO₂ concentration is increasing, but the forced ventilation cannot be performed due to insufficient power.

What is claimed is:

1. A vehicle comprising:
a generator configured to generate electric power along with drive of an engine;
an air conditioner configured to circulate a CO₂ refrigerant;
a battery configured to supply electric power to an auxiliary machine including the air conditioner;
a CO₂ sensor configured to detect a CO₂ concentration in a vehicle cabin;
an occupant sensor configured to detect presence or absence of an occupant; and
a controller, wherein the controller is configured to, when an ignition switch of the vehicle is OFF, the occupant is detected by the occupant sensor, a concentration detected by the CO₂ sensor exceeds a predetermined permissible concentration, and a remaining charge level of the battery is lower than a predetermined reference charge level, output an alert to the occupant without performing forced ventilation by the air conditioner.

2. The vehicle according to claim 1, wherein the alert is an alert that prompts the occupant to turn ON the ignition switch.

3. The vehicle according to claim 1, wherein:
the controller is configured to switch alert levels according to at least one of an elapsed period after output of the alert, the detected concentration, and the remaining charge level; and
the alert levels include at least a first alert level at which an alert is output only visually and a second alert level at which an alert including sound is output.

4. The vehicle according to claim 1, wherein the controller is configured to open a window of the vehicle in parallel with the alert or after output of the alert.

5. The vehicle according to claim 1, wherein the controller is configured to perform the forced ventilation by the air conditioner when the ignition switch of the vehicle is ON or the remaining charge level of the battery is equal to or higher than the reference charge level and the detected concentration exceeds the permissible concentration.
